(19) United States
(12) Patent Application Publication
(10) Pub. No.: US 2026/0195944 A1
(43) Pub. Date: Jul. 9, 2026

(54) METHOD, COMPUTING DEVICE, AND NON-TRANSITORY COMPUTER-READABLE RECORDING MEDIUM FOR GENERATING CUSTOMIZED IMAGES

(71) Applicant: SEIDMAN INT'L TRADING LTD., Taipei City (TW)

(72) Inventors: KUO-WEI LAI, Taipei City (TW); CHIA-HSIAN LIN, New Taipei City (TW); HSUAN OUYANG, Taipei City (TW); YU-BING TSAI, Taipei City (TW)

(73) Assignee: SEIDMAN INT'L TRADING LTD., Taipei City (TW)

(21) Appl. No.: 19/196,755

(22) Filed: May 2, 2025

(30) Foreign Application Priority Data
Jan. 9, 2025 (TW) 114100845

(51) Int. Cl. G06T 11/60; G06F 40/30; G06F 40/40; G06Q 30/0601

(52) U.S. Cl. CPC G06T 11/60; G06F 40/30; G06F 40/40; G06Q 30/0621

(57) ABSTRACT

A method for generating customized images is provided. The method comprises the following steps of receiving customization demand information; inputting the customization demand information into a semantic analysis model; performing a semantic analysis on the customization demand information through the semantic analysis model, and generating and outputting analyzed customization information based on the customization demand information; searching for a plurality of semantic images associated with the analyzed customization information from an image classification database, and receiving the semantic images; inputting the semantic images into an image analysis and screening model; and performing image analysis and screening on the plurality of semantic images through the image analysis and screening model, and screening the plurality of semantic images based on the customization demand information to obtain at least one first retrieved image, wherein the semantic analysis model, and the image analysis and screening model are respectively trained artificial intelligence engines.

### CROSS-REFERENCE TO RELATED APPLICATION

This non-provisional application claims priority under 35 U.S.C. § 119 (a) on patent application No. 114100845 filed in Taiwan, R.O.C. on Jan. 9, 2025, the entire contents of which are hereby incorporated by reference.

### BACKGROUND OF THE INVENTION

### 1. Field of the Invention

The present disclosure relates to a method, computing device, and non-transitory computer-readable recording medium for generating images, in particular to a method, computing device, and non-transitory computer-readable recording medium for generating customized images.

### 2. Description of the Related Art

Nowadays, users can create merchandise with customized images that meet users' personal preferences on the customized platform by operating computing devices, so that manufacturers can directly manufacture corresponding merchandise according to their creations. More specifically, users can perform editing operations such as adding/removing text, modifying the content/size/color/position of the text, newly adding/deleting the image, and modifying the size/position of the image on the blank merchandise image corresponding to the merchandise step by step, so as to create a customized image that meets the users' personal preferences on the merchandise image.

### BRIEF SUMMARY OF THE INVENTION

However, the traditional method of creating customized images requires the user operating the customized platform to perform each editing operation step by step, which requires more time for the user to complete each editing step to create a satisfactory customized image.

Therefore, solving the above-mentioned problems encountered by the traditional method of creating customized images and effectively improving the efficiency of generating customized images have become an urgent problem to be solved in this technical field.

In order to solve the above-mentioned problem, the present disclosure provides a method for generating customized images, the method is executed after a computer program product is loaded and executed by a computing device, the method includes the following steps of receiving customization demand information; inputting the customization demand information into a semantic analysis model; performing a semantic analysis on the customization demand information through the semantic analysis model, and generating and outputting analyzed customization information based on the customization demand information; searching for a plurality of semantic images associated with the analyzed customization information from an image classification database, and receiving the plurality of semantic images, and/or inputting at least one of the customization demand information and the analyzed customization information into an image generation model, and generating and outputting at least one initial image based on at least one of the customization demand information and the analyzed customization information through the image generation model; inputting the plurality of semantic images and/or the at least one initial image into an image analysis and screening model; and performing image analysis and screening on the plurality of semantic images and/or the at least one initial image through the image analysis and screening model, and screening the plurality of semantic images and/or the at least one initial image based on at least one of the customization demand information and the analyzed customization information to obtain at least one first retrieved image, wherein the semantic analysis model, the image generation model and the image analysis and screening model are respectively trained artificial intelligence engines.

In some embodiments, the method further includes the following steps of: determining whether a total number of the at least one first retrieved image is less than a predetermined value; and when the total number of the at least one first retrieved image is less than the predetermined value, inputting at least one of the customization demand information and the analyzed customization information into the image generation model, and generating and outputting at least one generated image based on at least one of the customization demand information and the analyzed customization information through the image generation model, wherein a total number of the at least one generated image is greater than or equal to a difference between the total number of the at least one first retrieved image and the predetermined value.

In some embodiments, the method further includes the following steps of: inputting the at least one generated image into the image analysis and screening model; performing image analysis and screening on the at least one generated image through the image analysis and screening model, and screening the at least one generated image based on at least one of the customization demand information and the analyzed customization information to obtain at least one second retrieved image; determining whether a total number of the at least one second retrieved image is less than the difference; and when the total number of the at least one second retrieved image is less than the difference, generating and outputting the at least one generated image again based on at least one of the customization demand information and the analyzed customization information through the image generation model, and screening the at least one generated image again based on at least one of the customization demand information and the analyzed customization information through the image analysis and screening model to obtain the at least one second retrieved image, until the total number of the at least one second retrieved image is greater than or equal to the difference.

In some embodiments, the step of performing a semantic analysis for the customization demand information through the semantic analysis model, and generating and outputting the analyzed customization information based on the customization demand information includes the following sub-steps of: performing language translation on the customization demand information through the semantic analysis model, and generating translated customization information based on the customization demand information; and performing semantic disassembly on the ctranslated customization information through the semantic analysis model, and generating and outputting the analyzed customization information based on the translated customization information.

In some embodiments, the method further includes the following steps of: inputting the at least one first retrieved image into an image editing model; and performing image editing on the at least one first retrieved image through the image editing model, and generating and outputting at least one edited image based on the at least one first retrieved image, wherein the image editing model is a trained artificial intelligence engine.

In some embodiments, the method further includes the following steps of: receiving a customized merchandise image corresponding to merchandise information for customization; inputting the at least one first retrieved image and the customized merchandise image into an image synthesis model; and performing image synthesis on the at least one first retrieved image and the customized merchandise image through the image synthesis model, and generating and outputting at least one synthesized image based on the at least one first retrieved image and the customized merchandise image, wherein the image synthesis model is a trained artificial intelligence engine.

In some embodiments, the method further includes the following steps of: selecting from the at least one synthesized image by a user to obtain a selected image and outputting the selected image to an ordering system.

Furthermore, the present disclosure also provides a computing device for generating customized images, including a storage module, configured to store a computer program product; and a processing module, configured to be coupled to the storage module, wherein after the processing module loads and executes the computer program product, the processing module is capable of executing any of the methods for generating customized images described in the present disclosure.

Furthermore, the present disclosure also provides a non-transitory computer-readable recording medium for generating customized images, after a computing device loads a computer program product stored in the non-transitory computer-readable recording medium and executes the computer program product, the computing device is capable of executing any of the methods for generating customized images described in the present disclosure.

Furthermore, the present disclosure also provides a computer program product for generating customized images, after a computing device loads and executes the computer program product, the computing device is capable of executing any of the methods for generating customized images described in the present disclosure.

Accordingly, the present disclosure offers advantages that cannot be achieved by the prior art. Specifically, one of the advantages of the present disclosure is that it can use artificial intelligence engines such as semantic analysis models, image generation models, and image analysis and screening models to generate customized images more efficiently, thereby reducing the time spent and/or the editing operations required to be performed when generating the customized images.

### BRIEF DESCRIPTION OF THE DRAWINGS

FIG. 1 is a schematic block diagram for illustrating a computing device for generating customized images of the present disclosure.

FIG. 2 is a flowchart for illustrating a method for generating customized images of a first embodiment of the present disclosure.

FIG. 3 is a flowchart for illustrating the method for generating customized images of a second embodiment of the present disclosure.

FIG. 4 is a flowchart for illustrating the method for generating customized images of a third embodiment of the present disclosure.

FIG. 5 is a flowchart for illustrating the method for generating customized images of a fourth embodiment of the present disclosure.

FIG. 6 is a flowchart for illustrating the method for generating customized images of a fifth embodiment of the present disclosure.

FIG. 7 and FIG. 8 are schematic diagrams for illustrating the execution results of the method for generating customized images of the present disclosure.

FIG. 9 is a schematic diagram for illustrating the execution result of an image editing model of the present disclosure.

### DETAILED DESCRIPTION OF THE INVENTION

The present disclosure will be described in detail by the following embodiments and the accompanying drawings, so as to assist a person having ordinary skill in the art (PHOSITA) to which the present disclosure belongs to understand the object, features and effects of the present disclosure.

It should be noted that the steps described herein may be performed sequentially, in reverse order, or by appropriately changing or skipping the order during the control process. It should be noted that the phrase “the first step may be performed after the second step” described in the present disclosure can be expressed as “the first step is followed directly after the second step” and/or “the second step is followed by the other steps (e.g., the third step) and then the first step”.

In addition, in the context of the present disclosure, it should be noted that terms such as “first”, “second” and “third” are used to distinguish differences between elements, and not to limit the elements themselves or to represent a particular order of elements. It should be noted that the same element or step may be indicated by the same reference numeral in the following description.

In addition, the term “coupling” as described in the present disclosure may be represented as “directly connected” and/or “indirectly connected”. Specifically, “the first element is configured to be coupled to the second element” can be expressed as “the first element is configured to be directly connected to the second element” and/or “the first element is configured to be indirectly connected to the second element”.

For the sake of brevity, although the steps in the method for generating customized images described in the present disclosure are performed by means of a single computing device. In some embodiments, the steps may also be performed by means of a plurality of computing devices. In other words, the method for generating customized images described in the present disclosure may also be realized through the cooperative operation of the plurality of computing devices (e.g., computing devices and a remote server).

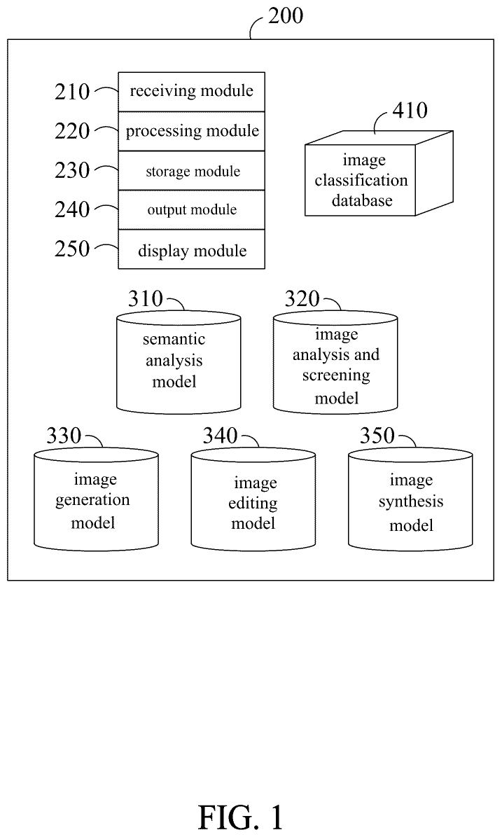

Referring to FIG. 1, FIG. 1 is a schematic block diagram for illustrating a computing device 200 for generating customized images of the present disclosure.

In some embodiments, the computing device 200 may be known to a person having ordinary skill in the art to which the present disclosure belongs, and specifically may be, for example, a desktop computer, a notebook computer, a laptop computer, a tablet computer, or other electronic devices with equivalent configurations, but are not limited thereto. The computing device 200 includes a processing module 220 and a storage module 230. In some embodiments, the computing device 200 further includes a receiving module 210, an output module 240 and/or a display module 250. Taking FIG. 1 as an example, the computing device 200 may include a receiving module 210, a processing module 220, a storage module 230, an output module 240 and a display module 250. Each module will be described in more detail below.

The receiving module 210 is configured to receive various data, images and/or instructions from, for example, a remote server (not shown in figures). In some embodiments, the receiving module 210 may be known to a person having ordinary skill in the art to which the present disclosure belongs, such as input and output interfaces of various models or specifications, but is not limited thereto.

The processing module 220 is configured to be coupled to the storage module 230, and is configured to execute each step of any of the methods for generating customized images described in the present disclosure. More specifically, after the processing module 220 loads and executes the computer program product, the processing module 220 can execute each step of any of the methods for generating customized images described in the present disclosure, thereby realizing any of the methods for generating customized images described in the present disclosure. In some embodiments, the processing module 220 may be known to a person having ordinary skill in the art to which the present disclosure belongs, such as a central processing unit or a graphic processing unit of various models or specifications, but is not limited thereto.

Furthermore, the processing module 220 may be configured to be coupled with the receiving module 210, the output module 240 and the display module 250, so as to receive specific data, images and/or instructions, etc., through the receiving module 210, output specific data, images and/or instructions, etc., through the output module 240 and display specific data and/or images, etc., through the display module 250.

The storage module 230 is configured to store a computer program product, so that after the processing module 220 loads and executes the stored computer program product, the processing module 220 can execute each step of any of the methods for generating customized images described in the present disclosure. The computer program product described in the present disclosure may include a series of codes and/or instruction sets, particularly specific codes and/or instruction sets corresponding to each step of any of the methods for generating customized images described in the present disclosure.

In some embodiments, the storage module 230 may include one or more non-volatile memory and one or more volatile memory. In some embodiments, volatile memory may be a product known to a person having ordinary skill in the art to which the present disclosure belongs, such as, various types of dynamic random access memory or static random access memory, but is not limited thereto. In some embodiments, non-volatile memory may be known to a person having ordinary skill in the art to which the present disclosure belongs, such as various types of read-only memory or flash memory, but is not limited thereto.

The output module 240 is configured to output various data, images, and/or instructions, etc., to, for example, a remote server (not shown in figures). In some embodiments, the output module 240 may be known to a person having ordinary skill in the art to which the present disclosure belongs, such as input and output interfaces of various models or specifications, but is not limited thereto.

The display module 250 is configured to display specific data and/or images, etc. In some embodiments, the display module 250 may be known to a person having ordinary skill in the art to which the present disclosure belongs, such as a display or display panel of various models or specifications, but is not limited thereto.

In addition, taking FIG. 1 as an example, the computing device 200 further includes an image classification database 410 for the storage of various classified images, such as images with classification labels or images with brief text descriptions, but is not limited thereto. In some embodiments, the image classification database 410 may be known to a person having ordinary skill in the art to which the present disclosure belongs, such as an image database of various models or specifications, but is not limited thereto.

Furthermore, taking FIG. 1 as an example, the computing device 200 further includes a semantic analysis model 310, an image analysis and screening model 320, an image generation model 330, an image editing model 340 and an image synthesis model 350. Each model will be described in more detail below.

The semantic analysis model 310 is configured to perform semantic analysis on the input content, in order to generate and output corresponding analysis results. More specifically, after the customization demand information is input into the semantic analysis model 310, the semantic analysis model 310 can perform semantic analysis on the customization demand information, so as to generate and output the analyzed customization information corresponding to the customization demand information based on the customization demand information. Also, the semantic analysis model 310 is a trained artificial intelligence engine. In some embodiments, the semantic analysis model 310 may be a known to a person having ordinary skill in the art to which the present disclosure belongs, such as ChatGPT, but is not limited thereto.

In addition, in some embodiments, the semantic analysis model 310 may include a language translation function block and a semantic disassembly function block. In the aspect, after the customization demand information is input into the semantic analysis model 310, the language translation function block in the semantic analysis model 310 can perform language translation on the customization demand information (e.g., translating various languages into English, but not limited thereto), so as to generate translated customization information corresponding to the customization demand information based on the customization demand information.

The semantic disassembly function block in the semantic analysis model 310 can perform semantic disassembly on the translated customization information after language translation (e.g., disassembling the subject, verb, object and/or adjective, etc., in the translated customization information, but not limited thereto), so as to generate disassembled customization information corresponding to the translated customization information based on the translated customization information. Then, the disassembled customization information is output as the analyzed customization information.

The image analysis and screening model 320 is configured to perform image analysis and screening on the image content, in order to generate and output the corresponding analysis and screening results. More specifically, after the plurality of semantic images, initial images and/or generated images are input to the image analysis and screening model 320, the image analysis and screening model 320 can respectively perform image analysis and screening on the input semantic images, initial images and/or the generated images, and screen the plurality of semantic images, the initial images and/or the generated images based on at least one of the customization demand information and the analyzed customization information, so as to obtain first retrieved images and/or second retrieved images. Also, the image analysis and screening model 320 is a trained artificial intelligence engine. In some embodiments, the image analysis and screening model 320 may be known to a person having ordinary skill in the art to which the present disclosure belongs, such as Imagga or Everypixel API, but is not limited thereto.

The image generation model 330 is configured to perform image generation on the input content, in order to generate and output the corresponding generated results. More specifically, after at least one of the customization demand information, the translated customization information and the analyzed customization information is input into the image generation model 330, the image generation model 330 can perform image generation in response to at least one of the customization demand information, the translated customization information and the analyzed customization information, so as to generate and output the initial images and/or the generated images corresponding to at least one of the customization demand information, the translated customization information and the analyzed customization information based on at least one of the customization demand information, the translated customization information and the analyzed customization information. In addition, the image generation model 330 is a trained artificial intelligence engine. In some embodiments, the image generation model 330 may be known to a person having ordinary skill in the art to which the present disclosure belongs, such as Stable Diffusion or OpenAI, but is not limited thereto.

The image editing model 340 is configured to perform image editing on the input content, in order to generate and output the corresponding edited results. More specifically, after the first retrieved images and/or the second retrieved images are input into the image editing model 340, the image editing model 340 can perform image editing for the input first retrieved images and/or the input second retrieved images, so as to generate and output screening editing images corresponding to the first retrieved images and/or the second retrieved images based on the first retrieved images and/or the second retrieved images. In some embodiments, the image editing model 340 can perform various image editing operations such as image matting, image filtering, image size cropping, image background addition, image object modification, image size expansion, and image enhancement, etc., thereby generating and outputting an edited image. Also, the image editing model 340 is a trained artificial intelligence engine. In some embodiments, the image editing model 340 may be known to a person having ordinary skill in the art to which the present disclosure belongs, such as Photoroom, but is not limited thereto.

Specifically, in some embodiments, the image editing model 340 may include an image matting function block (e.g., Photoroom, Stable Diffusion, but not limited thereto), an image filtering function block (e.g., Photoroom, DeepAI, Picsart, but not limited thereto), an image size cropping function block (e.g., Photoroom, Adobe, Google Cloud Vision, but not limited thereto), an image background addition function block (e.g., Photoroom, OpenAI, Picsart, but not limited thereto), an image object modification function block (e.g., Photoroom, Adobe, Picsart, but not limited thereto), an image size expansion function block (e.g., Photoroom, Adobe, Stability AI, but not limited thereto), and an image enhancement function block (e.g., Photoroom, Stable Diffusion, Imagen, but not limited thereto), wherein the image matting function block can be used to perform the image matting operation, the image filtering function block can be used to perform the image filtering operation, the image size cropping function block can be used to perform the image size cropping operation, the image background addition function block can be used to perform the image background addition operation, the image object modification function block can be used to perform the object modification operation in the image, the image size expansion function block can be used to perform the image size expansion operation, and the image enhancement function block can be used to perform the image enhancement operation.

The image synthesis model 350 is configured to perform image synthesis for the input content, in order to generate and output the corresponding synthesis results. More specifically, after the first retrieved image (or the second retrieved image or the edited image) together with the customized merchandise image corresponding to the merchandise information for customization are input into the image synthesis model 350, the image synthesis model 350 can perform image synthesis on the first retrieved image (or the second retrieved image or the edited image) and the customization merchandise image, so as to generate and output synthesized images based on the first retrieved image (or the second retrieved image or the edited image) and the customized merchandise image. In addition, the image synthesis model 350 is a trained artificial intelligence engine. In some embodiments, the image synthesis model 350 may be known to a person having ordinary skill in the art to which the present disclosure belongs, such as Zakeke or Threekit, but is not limited thereto.

By virtue of the above configuration, the computing device 200 is capable of performing each step of any of the methods for generating customized images described in the present disclosure, so as to realize any of the methods for generating customized images described in the present disclosure, thereby enabling users to utilize various artificial intelligence engines to generate customized images more efficiently, thus reducing the time spent and/or the editing operations required to be performed when generating the customized images.

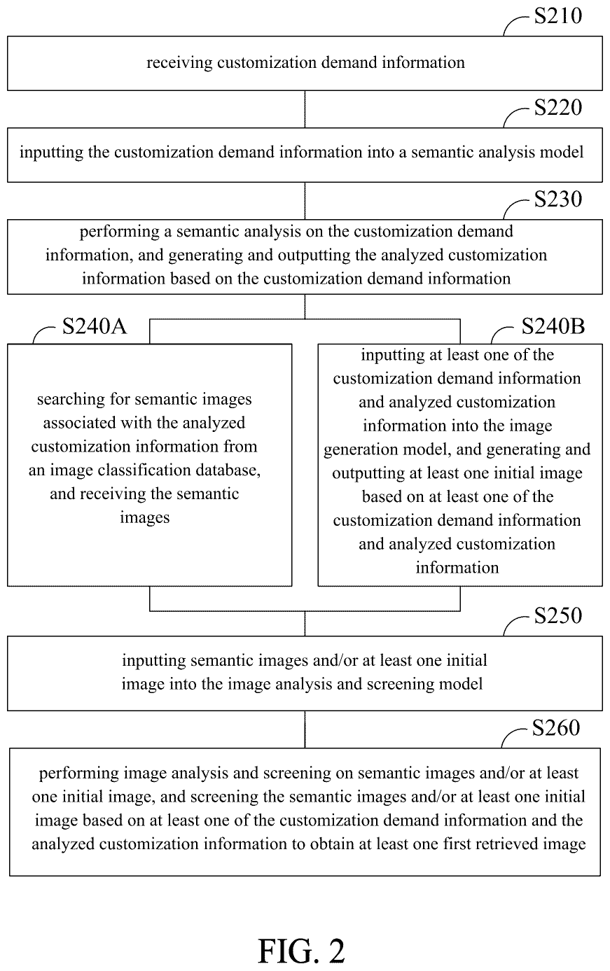

Referring to FIG. 2, FIG. 2 is a flowchart for illustrating the method for generating customized images of a first embodiment of the present disclosure. The method for generating the customized images can be performed by a processing module 220 of a computing device 200 as shown in FIG. 1, and the method may include steps S210, S220, S230, S240A, S240B, S250 and S260. It should be noted that in some embodiments, step S240A and step S240B may be optionally executed according to actual conditions such as the needs of users. In other words, in some embodiments, only step S240A, only step S240B, or both step S240A and step S240B are executed. Each step is described in more detail below.

In some embodiments, step S220 may be executed after step S210, step S230 may be executed after step S220, step S240A and step S240B may be executed after step S230, step S250 may be executed after step S240A and step S240B, and step S260 may be executed after step S250.

In step S210, customization demand information is received. More specifically, the computing device 200 can receive the customization demand information input by the user. In some embodiments, the customization demand information may include text content, image content, voice content, image style selection results, hashtag selection results and/or image presentation mode selection results, etc., but is not limited thereto.

Taking text content as an example, a user can input natural language texts in various languages, such as Chinese or English, for example, but is not limited to “a pig is sitting and eating snacks” to the computing device 200 through tools such as a keyboard.

Taking image content as an example, a user can upload images in various file formats to the computing device 200, and perform text content description for the uploaded image through various image description models known to a person having ordinary skill in the art to which the present disclosure belongs, so as to convert the uploaded image into an image description content corresponding to the uploaded image. In addition, in some embodiments, the image content may be, for example, a two-dimensional (2D) image file or a three-dimensional (3D) image file, but is not limited thereto.

Taking voice content as an example, a user can upload voice in various file formats to the computing device 200 and perform text converting on the uploaded voice through various voice-to-text tools known to a person having ordinary skill in the art to which the present disclosure belongs, so as to convert the uploaded voice into voice description content corresponding to the uploaded voice.

Taking image style selection result as an example, a user can select various image styles on the computing device 200 through tools such as a mouse, and the selected image style is input into the computing device 200 as the image style selection result. In some embodiments, the image style selection results may be various image styles, such as hand-drawn style, realistic style, cartoon style or comic style, which is known to a person having ordinary skill in the art to which the present disclosure belongs, but is not limited thereto.

Taking hashtag selection result as an example, a user can select various hashtags on the computing device 200 through tools such as a mouse, and the selected hashtag is input into the computing device 200 as the hashtag selection result. In some embodiments, the hashtag selection result may be various hashtags known to a person having ordinary skill in the art to which the present disclosure belongs, such as #cute, #animal, #relaxing, #funny, #cartoon, #adorable, but is not limited thereto.

Taking image presentation mode selection result as an example, a user can select various image presentation modes on the computing device 200 through tools such as a mouse, and the selected image presentation mode is input to the computing device 200 as the image presentation mode selection result. In some embodiments, the image presentation mode selection result may be various image presentation modes known to a person having ordinary skill in the art to which the present disclosure belongs, such as full width (i.e., complete coverage) presentation, non-full width presentation, or a plurality of random presentations, but is not limited thereto.

In step S220, the customization demand information is input into a semantic analysis model. More specifically, the computing device 200 can input the received customization demand information into a semantic analysis model (e.g., ChatGPT, but not limited to), such that the semantic analysis model can perform semantic analysis on the customization demand information.

In step S230, a semantic analysis is performed on the customization demand information, and the analyzed customization information is generated and output based on the customization demand information. More specifically, after the customization demand information is input into the semantic analysis model, the semantic analysis model can analyze the content of the customization demand information, and then generate and output the results corresponding to the customization demand information, that is, the analyzed customization information.

For example, after customization demand information such as “a pig is sitting and eating snacks” is input into ChatGPT, ChatGPT can generate and output analyzed customization information such as “Subject: [pig], Action: [sitting, eating], Object: [snacks]”.

In some embodiments, step S230 may include the following operations: (1) stop word filtering operation for excluding non-keywords such as connectives and modifiers, so as to focus more on the parsing of other words, (2) part-of-speech and semantic analysis operation for analyzing the part-of-speech (POS) of each word, (3) key element extraction operation for utilizing methods such as named entity recognition (NER), term frequency-inverse document frequency (TF-IDF), word to vector (word2vec) and other methods to extract elements in the sentence, (4) dependency parsing operation for analyzing the grammatical structure of the sentence, in order to understand who is doing what or what is being described in the sentence, etc., and (5) context-based analysis operation for identifying the purpose or intent of words based on context. Accordingly, it can perform semantic analysis on the customization demand information, and generate and output the analyzed customization information based on the customization demand information.

For example, after the customization demand information (i.e., the text content is “a sky picture suitable as a mobile phone wallpaper, the sky has a pale tint of pink color and gradient color when it is at sunset”) is input into the semantic analysis model, the non-keywords can be filtered out through the aforementioned stop word filtering operation, so as to focus more on “sky, the sky has a pale tint of pink color and gradient color when it is at sunset”; through the aforementioned part-of-speech and semantic analysis operation, the part-of-speech of each word can be analyzed, and then “noun: sky, sunset, pink, color”, “conjunction: when”, and “adjective: gradient” can be generated; by performing the aforementioned key element extraction operation, the elements can be extracted, and then “scene: sky”, “time/light: sunset”, and “color characteristic: pink color, gradient” can be generated;

by performing the aforementioned dependency parsing operation, the grammatical structure can be analyzed, and then “sky: subject”, “sunset time: time description”, and “pink color, gradient: color description” can be generated; by performing the aforementioned context-based analysis operation, the context can be analyzed, and then “suitable as a mobile phone wallpaper: description of use, irrelevant to the picture itself”, “sky picture: the main subject of the sentence, directly describing the scene”, “when the sky is at sunset: supplementing the time and light characteristics, enhancing the atmosphere of the picture”, and “having a pale tint of pink color and gradient color: specific picture style, used to perfect the details” can be generated.

In step S240A, an image classification database is searched for a plurality of semantic images associated with the analyzed customization information, and the plurality of semantic images are received. More specifically, since the image classification database stores various classified images (such as images with classification labels or images with brief text descriptions), the computing device 200 can compare the analyzed customization information with the classification labels or brief text descriptions of each image, and then search for the plurality of semantic images associated with the analyzed customization information from the image classification database, and then the computing device 200 can receive the plurality of semantic images associated with the analyzed customization information from the image classification database according to the search results.

In some embodiments, the image classification database may be an internal image gallery of the computing device 200. In addition, in some embodiments, the image classification database may also be an external image gallery other than the computing device 200, such as SVG Repo, reserve.freesvg, Pexels, Shutterstock, or Unsplash, but is not limited thereto.

Furthermore, in some embodiments, the plurality of images received from the image classification database may be, for example, two-dimensional (2D) graphic files or three-dimensional (3D) graphic files, but are not limited thereto. In addition, the aforementioned 2D/3D graphic files may further include information such as vectors, so as to be used for 2D/3D modeling, 2D/3D printing, etc., wherein the file format of the 2D graphic files may be, for example, SVG, EPS, AI, etc., and the file format of the 3D graphic files may be, for example, STL, OBJ, GLTF, FBX, etc., but are not limited to thereto.

In step S240B, at least one of the customization demand information and analyzed customization information is input into the image generation model, and based on at least one of the customization demand information and analyzed customization information, at least one initial image is generated and output. More specifically, the computing device 200 can input at least one of the customization demand information and the analyzed customization information into an image generation model (such as Stable Diffusion or OpenAI, but not limited thereto), and after at least one of the customization demand information and the analyzed customization information is input to the image generation model, the image generation model can analyze the content of at least one of the customization demand information and the analyzed customization information, and then generate and output a generation result corresponding to the at least one of the customization demand information and the analyzed customization information, that is, an initial image. Similarly, in some embodiments, the image generated by the image generation model may also be, for example, a 2D or 3D graphic file, and the 2D/3D graphic file may further include information such as vectors, so as to be used for 2D/3D modeling, 2D/3D printing, etc., but is not limited thereto.

In some embodiments, based on the number of semantic images obtained by executing step S240A and the number of initial images generated by executing step S240B, a corresponding number of semantic images and a corresponding number of initial images, such as 10 semantic images and 5 initial images are obtained, according to predetermined values, but are not limited thereto.

It should be noted that in some embodiments, the method for generating customized images described in the present disclosure may only execute step S240A without executing step S240B. In other embodiments, the method for generating customized images described in the present disclosure may only execute step S240B without executing step S240A. In other embodiments, the method for generating customized images described in the present disclosure may execute steps S240A and S240B in any order, whether step S240A is performed first, step S240B is performed first, or both steps are performed simultaneously. In this way, images can be provided in multiple ways, that is, semantic images obtained from the image classification database and/or initial images generated by the image generation model, and then possible options that can be provided to the user for selection can be expanded to increase practicality and/or availability.

In step S250, the plurality of semantic images and/or at least one initial image are input into the image analysis and screening model. More specifically, the computing device 200 may input the obtained semantic images and/or the generated at least one initial image into the image analysis and screening model (e.g., Imagga or Everypixel API, but not limited thereto), such that the image analysis and screening model can perform image analysis and screening on the semantic images and/or the at least one initial image.

In step S260, image analysis and screening are performed on the semantic images and/or at least one initial image, and the semantic images and/or at least one initial image are searched based on at least one of the customized demand information and the customized analysis information to obtain at least one first retrieved image.

More specifically, after the semantic search images and/or the at least one initial image are input into the image analysis and screening model, the image analysis and screening model can respectively analyze the content of each of the semantic images and/or the initial images, and set the content of at least one of the customization demand information and the analyzed customization information as a screening condition, and then screen the plurality of semantic images and/or the at least one initial to obtain the screening results that meet the screening conditions, that is, first retrieved images. Further, the computing device 200 can provide the first retrieved images that are ensured to meet the user's expectations as customized images for the user to select.

By virtue of the operation of each of the above steps, the computing device 200 can use the semantic analysis model, the image generation model and the image analysis and screening model to more efficiently generate customized images that meet the user's expectations, thereby reducing the time spent and/or the editing operations required by the user in generating the customized image, and improving stability and availability of the quality of the customized images.

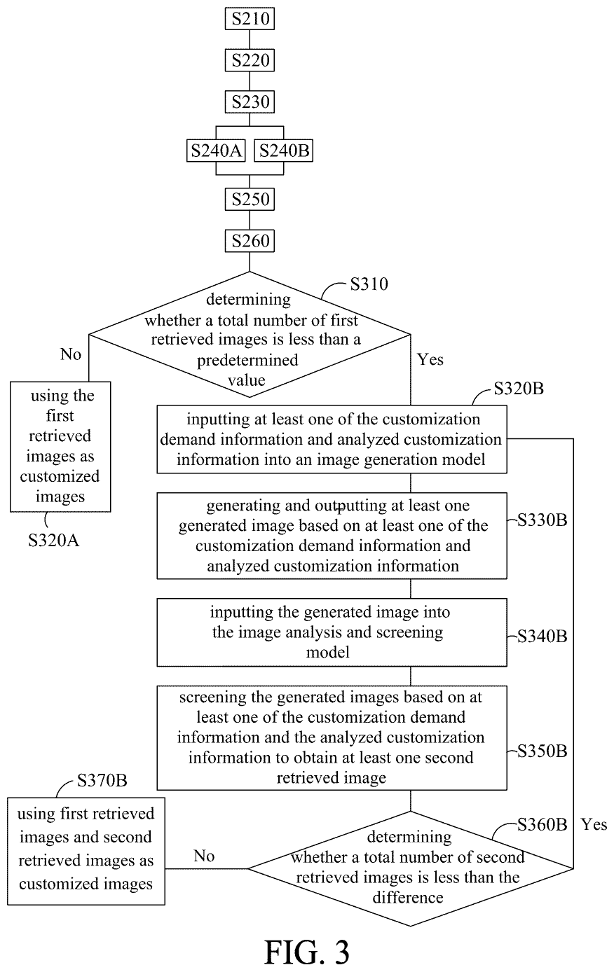

Referring to FIG. 3, FIG. 3 is a flowchart for illustrating the method for generating customized images of a second embodiment of the present disclosure.

The method shown in FIG. 3 may include steps S210, S220, S230, S240A, S240B, S250, and S260 as shown in FIG. 2, and further include steps S310, S320A, S320B, S330B, S340B, S350B, S360B, and S370B. Each of the steps further included in FIG. 3 is described in more detail below.

In some embodiments, step S310 may be executed after step S260, step S320A and step S320B may be executed after step S310, step S330B may be executed after step S320B, step S340B may be executed after step S330B, step S350B may be executed after step S340B, step S360B may be executed after step S350B, and step S370B may be executed after step S360B.

In step S310, it is determined whether a total number of first retrieved images is less than a predetermined value. More specifically, the computing device 200 can calculate the total number of first retrieved images, compare the total number of the first retrieved images with the predetermined value, and then determine whether the total number of the first retrieved images is less than the predetermined value. In some embodiments, the predetermined value may be a value set in advance by the user, which may be, for example, a positive integer greater than or equal to five, but is not limited thereto.

When the total number of the first retrieved images is greater than or equal to the predetermined value (i.e., the determination result of step S310 is “No”), the computing device 200 can continue to execute step S320A. When the total number of the first retrieved images is less than the predetermined value (i.e., the determination result of step S310 is “Yes”), the computing device 200 may continue to execute step S320B.

In step S320A, the first retrieved images are used as customized images. More specifically, since the total number of the first retrieved images is greater than or equal to the predetermined value, this means that the computing device 200 ensures that there is an adequate number of the first retrieved images available for the user to select after judgment, so the computing device 200 can further provide the adequate number of the first retrieved images as the customized images for the user to select.

In step S320B, at least one of the customization demand information and analyzed customization information is input into an image generation model. More specifically, the computing device 200 can input at least one of the customization demand information and the analyzed customization information into the image generation model (such as Stable Diffusion or OpenAI, but not limited thereto), such that the image generation model can perform image generation on at least one of the customization demand information and the analyzed customization information.

In step S330B, at least one generated image is generated and output based on at least one of the customization information and analyzed customization information. More specifically, after at least one of the customization information and the analyzed customization information is input into the image generation model, the image generation model can analyze the content of at least one of the customization demand information and the analyzed information, and then generate and output a generation result corresponding to at least one of the customization demand information and the analyzed customization information, that is, a generated image. Similarly, in some embodiments, the image generated by the image generation model may also be, for example, a 2D or 3D graphic file, and the 2D/3D graphic file may further include information such as vectors, so as to be used for 2D/3D modeling, 2D/3D printing, etc., but is not limited thereto. Furthermore, in order to make up an adequate number of the images, the computing device 200 can calculate the difference between the total number of the first retrieved images and the predetermined value, so that the total number of the generated images generated and output by the image generation model is greater than or equal to the aforementioned difference.

In addition, in some embodiments, the step S320B may be further adjusted to input the translated customization information into the image generation model, and the adjusted step S320B may be executed after the step S310 and the sub-step S410, so that the image generation model can perform image generation on the translated customization information, and generates and outputs a generated image corresponding to the translated customization information based on the translated customization information.

By virtue of the operation of each of the above steps, when the computing device 200 ensures that the total number of the first retrieved images that can be selected by the user is insufficient, it can further use the image generation model to additionally generate an adequate number of the generated images, and then the computing device 200 can more efficiently generate an adequate number of the customized images that meet the user's expectations, thereby increasing the number of customized images for the user to select.

In Step S340B, the generated image is input into the image analysis and screening model. More specifically, the computing device 200 may input the generated images into an image analysis and screening model (e.g., Imagga or Everypixel API, but not limited thereto), such that the image analysis and screening model can perform image analysis and screening on the generated images.

In step S350B, the generated images are screened based on at least one of the customization demand information and the analyzed customization information to obtain at least one second retrieved image. More specifically, after at least one generated image is input to the image analysis and screening model, the image analysis and screening model can respectively analyze the content of each of the generated images, and set the content of at least one of the customization demand information and the analyzed customization information as a screening condition, and then screen at least one generated image to obtain the screening results that meet the screening conditions, that is, a second retrieved image. Further, the second retrieved images can be used as customized images for the user to select.

By virtue of the operation of each of the above steps, the computing device 200 can ensure that the second retrieved images are in line with the customization demand information that the user inputs, and then the second retrieved images are used as customized images for the user to select, and this operation ensures that the customized image provided to the user for selection is in line with the user's expectation, thereby improving the quality stability and availability of the customized images.

In step S360B, it is determined whether a total number of second retrieved images is less than the difference. More specifically, the computing device 200 can calculate the total number of second retrieved images, compare the total number of the second retrieved images with the difference, and then determine whether the total number of the second retrieved images is less than the difference.

When the total number of the second retrieved images is greater than or equal to the difference (i.e., the determination result of step S360B is “No”), the computing device 200 can continue to execute step S370B; and when the total number of the second retrieved images is less than the difference (i.e., the determination result of step S360B is “Yes”), the computing device 200 would go back to step S320B and execute steps S320B, S330B, S340B, S350B and S360B again until the total number of the second retrieved images is greater than or equal to the difference.

In step S370B, first retrieved images and second retrieved images are used as customized images. More specifically, since the total number of the second retrieved images is greater than or equal to the difference, this means that the computing device 200 ensures that the total number of the first retrieved images and the second retrieved images has been greater than or equal to the predetermined value, so that the computing device 200 can further provide an adequate number of the first retrieved images and the second retrieved images that are ensured to meet the user's expectations as customized images for the user to select.

By virtue of the operation of each of the above steps, the computing device 200 can ensure that the total number of the second retrieved images can make up the difference between the total number of the first retrieved images and the predetermined value, and then an adequate number of the first retrieved images and the second retrieved images are used as customized images for the user to select, thereby increasing options available for the user. In addition, both the first retrieved images and the second retrieved images are screened and obtained by the image analysis and screening model, which helps to improve the quality stability and availability of the customized images.

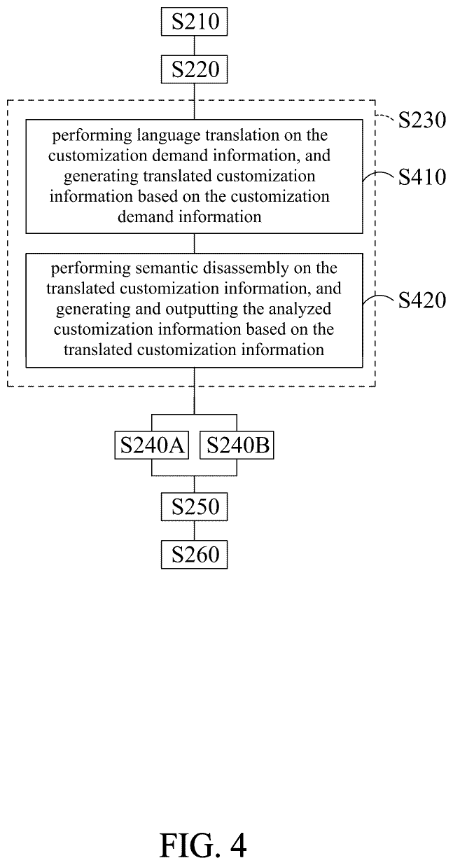

Referring to FIG. 4, FIG. 4 is a flowchart for illustrating the method for generating customized images of a third embodiment of the present disclosure.

The method shown in FIG. 4 may include steps S210, S220, S230, S240A, S240B, S250 and S260 and sub-steps S410 and S420, wherein steps S210, S220, S240A, S240B, S250 and S260 may be substantially the same to the steps shown in FIG. 2, and step S230 may be completed by executing sub-steps S410 and S420. Sub-steps S410 and S420 are described in more detail below.

In some embodiments, sub-step S410 may be executed after step S220, and sub-step S420 may be executed after sub-step S410.

In sub-step S410, language translation is performed on the customization demand information, and analyzed customization information is generated based on the customization demand information. More specifically, after the customization demand information is input into the semantic analysis model, the semantic analysis model can analyze the customization demand information, and then generate a language translation result corresponding to the customization demand information, i.e., the translated customization information. For example, after customization demand information such as “A pig is sitting and eating snacks (Chinese)” is input into ChatGPT, ChatGPT can generate and output translated customization information as “A pig is sitting and eating snacks (English)”.

In sub-step S420, semantic disassembly is performed on the translated customization information, and the analyzed customization information is generated and output based on the translated customization information. More specifically, the semantic analysis model can analyze the translated customization information, and then generate and output the semantic disassembly results corresponding to the translated customization information, that is, dissembled customization information. For example, ChatGPT can perform semantic disassembly on translated customization information such as “A pig is sitting and eating snacks” to generate disassembled customization information such as “Subject: [pig], Action: [sitting, eating], Object: [snacks]”. Further, the semantic analysis model can output the disassemble customization information as analyzed customization information.

By virtue of the operation of each of the above steps, since the semantic analysis model can convert the customization demand information of various different languages into the translated customization information of a specific language (such as English, but not limited thereto), the semantic analysis model can convert the translated customization information into the disassembled customization information according to the grammar of the specific language, and the disassembled customization information is output as the analyzed customization information, and then the computing device 200 can process customization demand information of users with different native languages, in order to increase the number of applicable objects, and improve the consistency and stability of the processing of customization demand information in various languages.

By virtue of the operation of each of the above steps, the computing device 200 can use a number of different analysis results (i.e., disassembled customization information) to search for more relevant semantic images from the image classification database, so as to make the obtained semantic images more in line with the user's expectations, thereby improving the user experience.

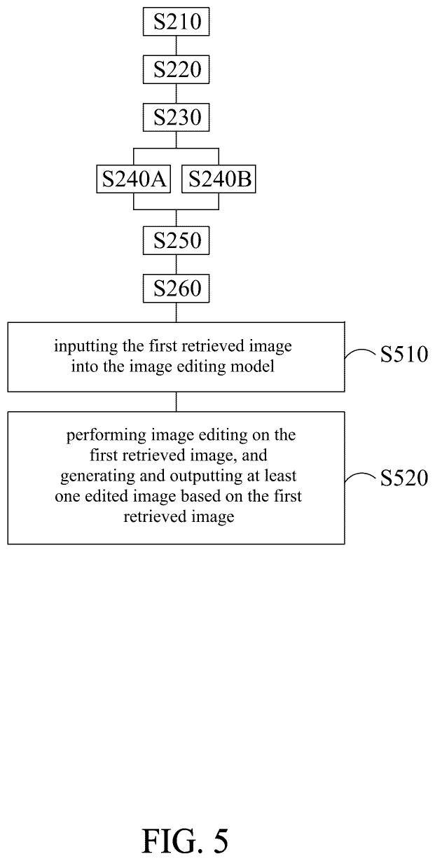

Referring to FIG. 5, FIG. 5 is a flowchart for illustrating the method for generating customized images of a fourth embodiment of the present disclosure.

The method shown in FIG. 5 may include steps S210, S220, S230, S240A, S240B, S250, and S260 as shown in FIG. 2, and further include steps S510 and S520. Each of the steps further included in FIG. 5 is described in more detail below.

In some embodiments, step S510 may be executed after step S260, and step S520 may be executed after step S510.

In step S510, the first retrieved image is input into an image editing model. More specifically, the computing device 200 can input the first retrieved image into an image editing model (e.g., Photoroom, but not limited thereto), such that the image editing model can perform various image editing operations such as image matting, image filtering, image size cropping, image background addition, image object modification, image size expansion, and image enhancement on the first retrieved image.

In step S520, image editing is performed on the first retrieved image, and at least one edited image is generated and output based on the first retrieved image. For example, taking image matting as an example, after the first retrieved images are input into the image editing model, the image editing model can respectively analyze the content of each of the first retrieved images, in order to identify the background elements (i.e., parts that are not related to the content of the customization demand information and/or the analyzed customization information) in each of the first retrieved images, and then generate and output the corresponding matting results, that is, the edited images after image matting. Similarly, after analyzing the contents of the first retrieved images, the image editing model can also generate and output the edited images after image filtering, the edited images after image size cropping, the edited images after image background addition, the edited images after image object modification, the edited images after image size expansion, or the edited images after image enhancement.

In addition, in some embodiments, the step S510 may be further adjusted to input the first retrieved image determined as a customized image into the image editing model, and the adjusted step S510 is executed after the step S320A, so that the image editing model performs image editing on the first retrieved image, and generates and outputs the corresponding edited image based on the first retrieved image. Also, in some embodiments, the step S510 may be further adjusted to input the first retrieved image and the second retrieved image that are determined as customized images into the image editing model, and then the adjusted step S510 is executed after the step S370B, so that the image editing model performs image editing on the first retrieved image and the second retrieved image, and generates and outputs the corresponding edited image based on the first retrieved image and the second retrieved image.

By virtue of the operation of each of the above steps, the computing device 200 can automatically perform processing such as removing background for the first retrieved images and/or the second retrieved images, thereby reducing the time spent and/or editing operations required for users to manually perform various image edits, in order to improve the convenience of operation and user's experience.

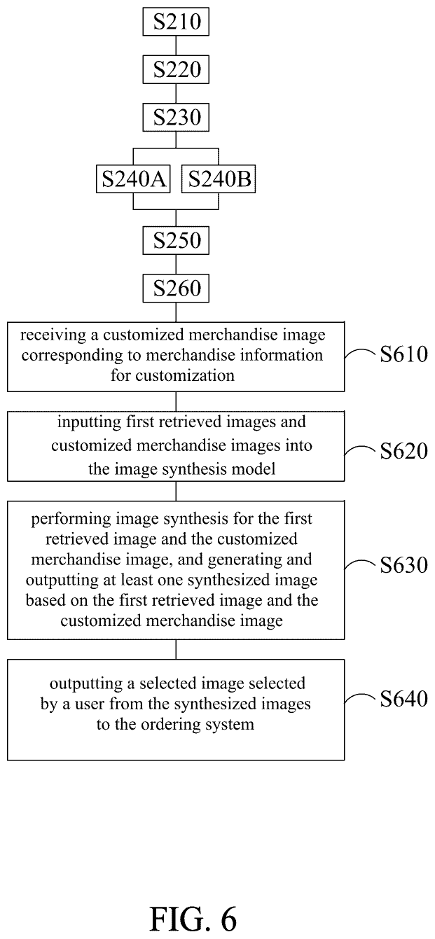

Referring to FIG. 6, FIG. 6 is a flowchart for illustrating the method for generating customized images of a fifth embodiment of the present disclosure.

The method shown in FIG. 6 may include steps S210, S220, S230, S240A, S240B, S250, and S260 as shown in FIG. 2, and further include steps S610, S620, S630 and S640. Each of the steps further included in FIG. 6 is described in more detail below.

In some embodiments, step S610 may be executed after step S260, step S620 may be executed after step S610, step S630 may be executed after step S620, and step S640 may be executed after step S630.

In step S610, a customized merchandise image corresponding to merchandise information for customization is received. More specifically, the user can select the merchandise intended to be customized on the computing device 200 through tools such as a mouse, and after the user completes the click, the computing device 200 can receive merchandise information of the merchandise clicked by the user, and the computing device 200 can receive a customized merchandise image corresponding to the merchandise information for customization from a merchandise image database according to the received merchandise information for customization. In some embodiments, the merchandise for users to customize can be various physical objects, such as mobile phone cases with various models or specifications, backpacks, clothing or mugs, but are not limited thereto; and the merchandise information for customization refers to the content describing each of the aforementioned merchandise, such as information about the brand, model, size or color of a certain mobile phone case, but is not limited thereto. The customized merchandise image refers to an image drawn according to the physical appearance of the aforementioned merchandise, such as the layout image of a certain mobile phone case. In addition, in some embodiments, the merchandise image database may be known to a person having ordinary skill in the art to which the present disclosure belongs, such as image databases of various models or specifications, but is not limited thereto. Furthermore, in some embodiments, step S610 may be the first step to be executed, that is, step S210 is executed after step S610.

In step S620, first retrieved images and customized merchandise images are input into an image synthesis model. More specifically, the computing device 200 can input the first retrieved image and the customized merchandise image into an image synthesis model (such as Zakeke or Threekit, but not limited thereto), such that the image synthesis model can perform image synthesis for the first retrieved image and the customized merchandise image.

In step S630, image synthesis is performed for the first retrieved image and the customized merchandise image, and at least one synthesized image is generated and output based on the first retrieved image and the customized merchandise image. More specifically, after the first retrieved image and the customized merchandise image are input into the image synthesis model, the image synthesis model can first identify the customized merchandise images that have been defined in advance as synthesizable and non-synthesizable regions, then synthesize the first retrieved images into the synthesizable regions of the customized merchandise images, and then generate and output the corresponding synthesis results, that is, the synthesized images. In addition, in some embodiments, the image synthesis model can adjust the synthesis method between the first retrieved image and the customized merchandise image according to the image presentation mode selection result clicked by the user, for example, the first retrieved image is synthesized on the customized merchandise image in the presentation mode of a single full width.

In addition, in some embodiments, the step S620 may be further adjusted to input the first retrieved image determined as a customized image and the customized merchandise image into the image synthesis model, and then the adjusted step S620 is executed after the steps S610 and S320A, so that the image synthesis model respectively performs image synthesis for the first retrieved image and the customized merchandise image, and the corresponding synthesized images are respectively generated and output based on the first retrieved image and the customized merchandise image. Also, in some embodiments, the step S620 may be further adjusted to input the first retrieved image and the second retrieved image that are determined as customized images as well as the customized merchandise image into the image synthesis model, and then the adjusted step S620 is executed after the steps S610 and S370B, so that the image synthesis model respectively performs image synthesis for the first retrieved image and the second retrieved image as well as the customized merchandise image, and the corresponding synthesized images are respectively generated and output based on the first retrieved image and the second retrieved image as well as the customized merchandise image. In addition, in some embodiments, the step S620 may be further adjusted to input the edited image and the customized merchandise image into the image synthesis model, and then the adjusted step S620 is executed after the steps S610 and S520, so that the image synthesis model respectively performs image synthesis for the edited image and the customized merchandise image, and the corresponding synthesized images are respectively generated and output based on the edited image and the customized merchandise image.

By virtue of the operation of each of the above steps, the computing device 200 can automatically perform processing of the image synthesis for the first retrieved image and/or the second retrieved image and the customized merchandise image, so that the image processing engineer no longer needs to set the shielding areas of the layers of each image and/or the customized merchandise image, thereby reducing the time spent and/or processing operations required by the image processing engineer to set the image, so as to achieve the effect of saving time and effort.

In step S640, selecting from the synthesized image is performed by the user to obtain a selected image, and the selected image is output to an ordering system. More specifically, the computing device 200 can display each synthesized image to the user for the user to choose. Then, the user can select a synthesized image that aligns with to the user's expectations on the computing device 200 through tools such as a mouse, and after the user completes the click, the computing device 200 can receive the synthesized image selected by the user, and the synthesized image is output to the ordering system as a selected image, so that the ordering system arranges the manufacturing and shipping procedures of the corresponding merchandise for the selected image, and then provides the user with physical customized merchandise corresponding to the selected image. In some embodiments, the ordering system may be a system built by each manufacturer capable of receiving orders for customized merchandise, but is not limited thereto.

By virtue of the operation of each of the above steps, the computing device 200 can directly output the selected image that aligns with the user's expectations to the ordering system, thereby improving the user's convenience of operation and improving the user's experience.

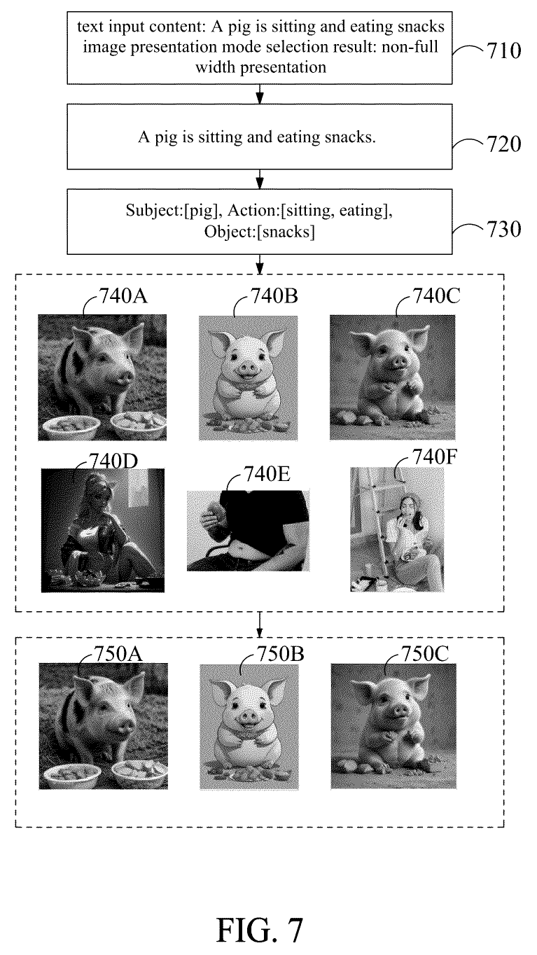

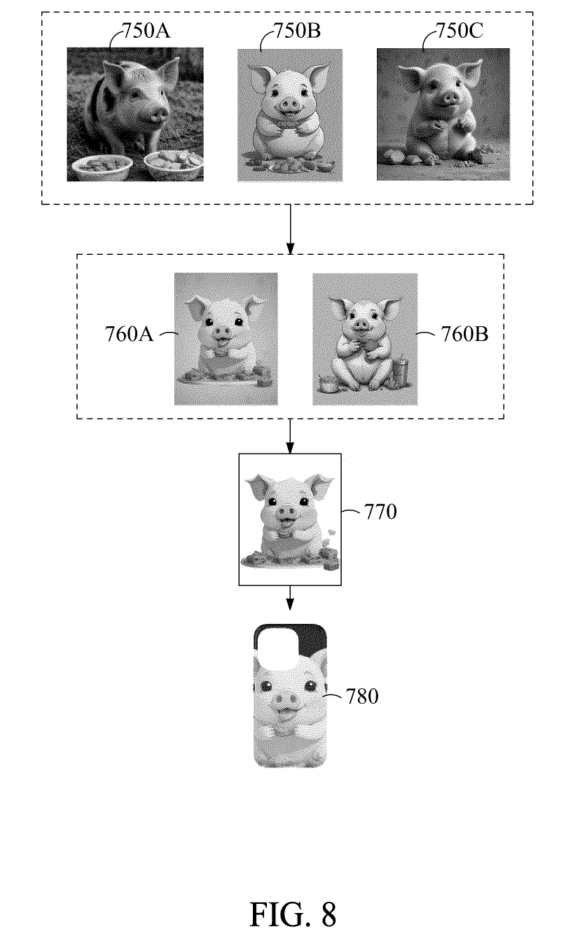

Referring to FIG. 7 and FIG. 8, FIG. 7 and FIG. 8 are schematic diagrams for illustrating the execution results of the method for generating customized images of the present disclosure.

By executing step S210, the computing device 200 can receive customization demand information 710 input by the user, wherein the content of the customization demand information 710 includes the text content of “A pig is sitting and eating snacks (Chinese)” and the image presentation mode selection result of “non-full width presentation”.

By executing step S220, the computing device 200 may input the customization demand information 710 into a semantic analysis model (e.g., ChatGPT, but not limited thereto). By executing sub-step S410 in step S230, the semantic analysis model can perform language translation on the customization demand information 710 to generate corresponding translated customization information 720, that is, “A pig is sitting and eating snacks (English)”. By executing sub-step S420 in step S230, the semantic analysis model can perform semantic disassembly on the translated customization information 720 to generate corresponding disassembled customization information, that is, “Subject: [pig], Action: [sitting, eating], Object: [snacks]”, wherein the disassembled customization information is output as analyzed customization information 730.

By executing step S240A, the computing device 200 may search for a plurality of semantic images associated with the analyzed customization information from the image classification database, and receive the semantic images, namely, a first semantic image 740A, a second semantic image 740B, a third semantic image 740C, a fourth semantic image 740D, a fifth semantic image 740E and a sixth semantic image 740F.

By executing step S250, the computing device 200 may input each of the semantic images into an image analysis and screening model (e.g., Imagga or Everypixel API, but not limited thereto). By executing step S260, the image analysis and screening model can respectively analyze each of the semantic images, set the customization demand information 710 as a screening condition, and then screen the semantic images to obtain first retrieved images that meet the screening condition, namely, an image 750A, an image 750B, and an image 750C.

By executing step S310, the computing device 200 can determine whether the total number of the first retrieved images (i.e., 3 pieces) is less than the predetermined value (e.g., 5). Since the total number of the first retrieved images is less than the predetermined value, the computing device 200 continues to execute step S320B.

By executing steps S320B, S330B, S340B, S350B and S360B, the computing device 200 can generate and output second retrieved images, i.e., an image 760A and an image 760B that meets the screening conditions according to the difference (i.e., 2) between the total number of the first retrieved images and the predetermined value. By executing step S370B, the computing device 200 may use the image 750A, the image 750B, the image 750C, the image 760A and the image 760B as customized images.

By executing steps S510, the computing device 200 may respectively input each of the first retrieved images and the second retrieved images into an image editing model (e.g., Stable Diffusion, but not limited thereto). By executing step S520, the image editing model can respectively perform image editing on each of the first retrieved images and the second retrieved images, and then generate and output the corresponding edited image. Taking the image 760A as an example, after the image 760A is input into the image editing model, the image editing model can perform image editing on the image 760A, and then generate and output a corresponding edited image 770 after image matting. Similarly, the image editing model can also generate and output the edited images respectively corresponding to the image 750A, the image 750B, the image 750C, and the image 760B.

By executing step S610, the computing device 200 may receive a customized merchandise image (e.g., a certain mobile phone case) corresponding to the merchandise information for customization from the merchandise image database according to the merchandise information received. By executing step S620, the computing device 200 may input the edited image 770 and the customized merchandise image into an image synthesis model (e.g., Zakeke or Threekit, but not limited thereto). By executing step S630, the image synthesis model can perform image synthesis for the edited image 770 and the customized merchandise image, and then generate and output the corresponding synthesized image 780 for the user to select.

By executing step S640, the computing device 200 outputs a selected image selected by the user from a number of synthesized images to an ordering system, such that the manufacturer manufactures a physical customized merchandise corresponding to the selected image.

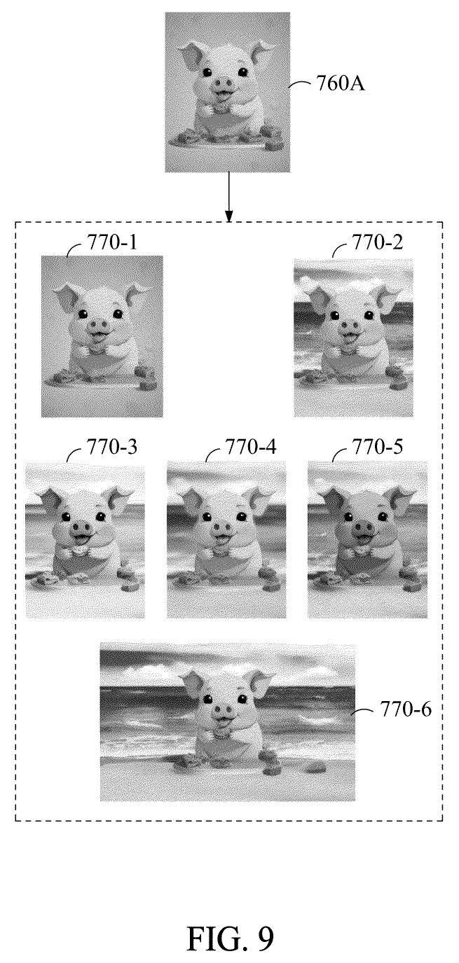

Referring to FIG. 9, FIG. 9 is a schematic diagram for illustrating the execution result of an image editing model of the present disclosure.

Taking FIG. 9 as an example, by executing step S520, the computing device 200 can not only perform the image editing on the image 760A, and then generate and output the edited image 770 after image matting as shown in FIG. 8, but also generate and output an edited image 770-1 after object modification as shown in FIG. 9 (i.e., deleting part of snacks in the image 760A).

In addition, in some embodiments, the image editing model can sequentially execute multiple image editing operations. Taking FIG. 9 as an example, the computing device 200 can generate and output the edited image 770-1 after object modification. Then, the computing device 200 can perform image editing on the edited image 770-1 after object modification, and then generate and output an edited image 770-2 after image background addition, an edited image 770-3 after image filtering (black-and-white filter), an edited image 770-4 after image filtering (background blur filter) or an edited image 770-5 after image filtering (brown filter). The computing device 200 can perform image editing on the edited image 770-2 after image background addition, and then generate and output an edited image 770-6 after image size expansion.

Further, after respectively receiving five sets of different customization demand information (the text content of these five sets is “having a picnic on the grass with fruit basket and flowers”, “the sky has a pale tint of pink color and gradient color when it is at sunset”, “a cat wearing kimono”, “glowing Christmas tree”, “flowing liquid metal”, and respectively selecting one image style selection result), the method for generating customized images described in the present disclosure respectively generates customized images for these five different sets of customization demand information, and an average of the accuracy of the generated results (that is, after users review the customized images, the users believe that these customized images align with the their expectations) is 97.1%.

In some embodiments, the steps in the method for generating customized images described in the present disclosure may be further combined, replaced, repeatedly executed and/or modified, so as to generate new embodiments within the scope disclosed in the present disclosure.

In some embodiments, a person having ordinary skill in the art to which the present disclosure belongs can use programming language such as C#, database operations such as Entity Framework, web development design frameworks such as ASP.NET MVC, database service programs such as MS SQL Server, web standard markup language such as HTML, functional libraries such as Javascript, Jquery, Vue.js, so as to realize any of the methods for generating customized images described in the present disclosure. Also, a person having ordinary skill in the art to which the present disclosure belongs can use the C# functional library shown in Table (1) below.

TABLE (1)
C# functional library

Microsoft.AspNetCore.App.Ref\6.0.22\
Microsoft.NETCore.App.Ref\6.0.22\
Microsoft.CodeAnalysis.NetAnalyzers
Microsoft.AspNetCore.Analyzers
Microsoft.AspNetCore.Components.SdkAnalyzers
Microsoft.CodeAnalysis.CSharp.NetAnalyzers
Microsoft.AspNetCore.Mvc.Analyzers
Microsoft.NET.Sdk.Razor.SourceGenerators
System.Collections.Immutable
Microsoft.Extensions.Logging.Generators
MessagePackAnalyzer
Microsoft.AspNetCore.Mvc.Razor.Extensions
Microsoft.CodeAnalysis.ExternalAccess.RazorCompiler
Microsoft.Entity FrameworkCore.Analyzers
Microsoft.CodeAnalysis.Analyzers
Microsoft.AspNetCore.Razor.Language
Microsoft.Code Analysis.CSharp.Analyzers
System.Text.Json.SourceGeneration
Microsoft.AspNetCore.App.CodeFixes
Microsoft.AspNetCore.Razor.Utilities.Shared
Microsoft.Extensions.ObjectPool
Microsoft.AspNetCore.App.Analyzers
Microsoft.CodeAnalysis.Razor
system.drawing.common\8.0.7\
sixlabors.imagesharp\3.1.5\
microsoft.entityframeworkcore.sqlserver\6.0.33\
microsoft.entityframeworkcore.design\6.0.32\
microsoft.aspnetcore.identity.entityframeworkcore \6.0.32\
microsoft.aspnetcore.authentication.cookies\2.1.16\
microsoft.entityframeworkcore.tools\6.0.30\
microsoft.visualstudio.web.codegeneration.design\6.0.17\

In some embodiments, each step in the method for generating customized images described in the present disclosure may be stored in a non-transitory computer-readable recording medium, which may be, but is not limited to, a hard disk, an optical disk, a magnetic disk, a USB flash drive, or a database accessible from the network. After the non-transitory computer-readable recording medium loads the computer program product stored inside through the computing device and the computer program product is executed, the computing device is capable of realizing any of the methods for generating customized images described in the present disclosure.

In some embodiments, the computer program product for generating customized images described in the present disclosure may include each step in the method for generating customized images described in the present disclosure, so that the computing device can realize any of the methods for generating customized images described in the present disclosure after loading the computer program product and executing the computer program product.

The present application has been further explained by the above embodiments and the accompanying drawings, but a person having ordinary skill in the art to which the present application belongs may still make many modifications and changes without departing from the scope and spirit proposed in the claims of the present application. Therefore, the protection scope of the present application shall still be defined by the claims, and shall not be limited by the content disclosed in the specification.

What is claimed is:

1. A method for generating customized images, the method being executed after a computer program product is loaded and executed by a computing device, the method comprising the following steps of:
receiving customization demand information;
inputting the customization demand information into a semantic analysis model;
performing a semantic analysis on the customization demand information through the semantic analysis model, and generating and outputting analyzed customization information based on the customization demand information;
searching for a plurality of semantic images associated with the analyzed customization information from an image classification database, and receiving the plurality of semantic images, and/or inputting at least one of the customization demand information and the analyzed customization information into an image generation model, and generating and outputting at least one initial image based on at least one of the customization demand information and the analyzed customization information through the image generation model;
inputting the plurality of semantic images and/or the at least one initial image into an image analysis and screening model; and
performing image analysis and screening on the plurality of semantic images and/or the at least one initial image through the image analysis and screening model, and screening the plurality of semantic images and/or the at least one initial image based on at least one of the customization demand information and the analyzed customization information to obtain at least one first retrieved image,
wherein the semantic analysis model, the image generation model and the image analysis and screening model are respectively trained artificial intelligence engines.

2. The method according to claim 1, wherein the method further comprises the following steps of:
determining whether a total number of the at least one first retrieved image is less than a predetermined value; and
when the total number of the at least one first retrieved image is less than the predetermined value, inputting at least one of the customization demand information and the analyzed customization information into the image generation model, and generating and outputting at least one generated image based on at least one of the customization demand information and the analyzed customization information through the image generation model,
wherein a total number of the at least one generated image is greater than or equal to a difference between the total number of the at least one first retrieved image and the predetermined value.

3. The method according to claim 2, wherein the method further comprises the following steps of:
inputting the at least one generated image into the image analysis and screening model;
performing image analysis and screening on the at least one generated image through the image analysis and screening model, and screening the at least one generated image based on at least one of the customization demand information and the analyzed customization information to obtain at least one second retrieved image;
determining whether a total number of the at least one second retrieved image is less than the difference; and
when the total number of the at least one second retrieved image is less than the difference, generating and outputting the at least one generated image again based on at least one of the customization demand information and the analyzed customization information through the image generation model, and screening the at least one generated image again based on at least one of the customization demand information and the analyzed customization information through the image analysis and screening model to obtain the at least one second retrieved image, until the total number of the at least one the second retrieved image is greater than or equal to the difference.

4. The method according to claim 1, wherein the step of performing a semantic analysis on the customization demand information through the semantic analysis model, and generating and outputting the analyzed customization information based on the customization demand information comprises the following sub-steps:
performing language translation on the customization demand information through the semantic analysis model, and generating translated customization information based on the customization demand information; and
performing semantic disassembly on the translated customization information through the semantic analysis model, and generating and outputting the analyzed customization information based on the translated customization information.

5. The method according to claim 1, wherein the method further comprises the following steps of:
inputting the at least one first retrieved image into an image editing model; and
performing image editing on the at least one first retrieved image through the image editing model, and generating and outputting at least one edited image based on the at least one first retrieved image,
wherein the image editing model is a trained artificial intelligence engine.

6. The method according to claim 1, wherein the method further comprises the following steps of:
receiving a customized merchandise image corresponding to merchandise information for customization;
inputting the at least one first retrieved image and the customized merchandise image into an image synthesis model; and
performing image synthesis on the at least one first retrieved image and the customized merchandise image through the image synthesis model, and generating and outputting at least one synthesized image based on the at least one first retrieved image and the customized merchandise image,
wherein the image synthesis model is a trained artificial intelligence engine.

7. The method according to claim 6, wherein the method further comprises the following steps of:
selecting from the at least one synthesized image by a user to obtain a selected image and outputting the selected image to an ordering system.

8. A computing device for generating customized images, comprising:
a storage module, configured to store a computer program product; and
a processing module, configured to be coupled to the storage module,
wherein after the processing module loads and executes the computer program product, the processing module performs a method for generating customized images, the method for generating customized images comprising the following steps of:
receiving customization demand information;
inputting the customization demand information into a semantic analysis model;
performing a semantic analysis on the customization demand information through the semantic analysis model, and generating and outputting analyzed customization information based on the customization demand information;
searching for a plurality of images associated with the analyzed customization information from an image classification database, and receiving the plurality of semantic images, and/or inputting at least one of the customization demand information and the analyzed customization information into an image generation model, and generating and outputting at least one initial image based on at least one of the customization demand information and the analyzed customization information through the image generation model;
inputting the plurality of semantic images and/or the at least one initial image into an image analysis and screening model; and
performing image analysis and screening on the plurality of semantic images and/or the at least one initial image through the image analysis and screening model, and screening the plurality of semantic images and/or the at least one initial image based on at least one of the customization demand information and the analyzed customization information to obtain at least one first retrieved image,
wherein the semantic analysis model, the image generation model and the image analysis and screening model are respectively trained artificial intelligence engines.

9. The computing device according to claim 8, wherein the method for generating customized images further comprises the following steps of:
determining whether a total number of the at least one first retrieved image is less than a predetermined value; and
when the total number of the at least one first retrieved image is less than the predetermined value, inputting at least one of the customization demand information and the analyzed customization information into the image generation model, and generating and outputting at least one generated image based on at least one of the customization demand information and the analyzed customization information through the image generation model,
wherein a total number of the at least one generated image is greater than or equal to a difference between the total number of the at least one first retrieved image and the predetermined value.

10. The computing device according to claim 9, wherein the method for generating customized images further comprises the following steps of:
inputting the at least one generated image into the image analysis and screening model;
performing image analysis and screening on the at least one generated image through the image analysis and screening model, and screening the at least one generated image based on at least one of the customization demand information and the analyzed customization information to obtain at least one second retrieved image;
determining whether a total number of the at least one second retrieved image is less than the difference; and
when the total number of the at least one second retrieved image is less than the difference, generating and outputting the at least one generated image again based on at least one of the customization demand information and the analyzed customization information through the image generation model, and screening the at least one generated image again based on at least one of the customization demand information and the analyzed customization information through the image analysis and screening model to obtain the at least one second retrieved image, until the total number of the at least one second retrieved image is greater than or equal to the difference.

11. The computing device according to claim 8, wherein the step of performing a semantic analysis on the customization demand information through the semantic analysis model, and generating and outputting the analyzed customization information based on the customization demand information comprises the following sub-steps:
performing language translation on the customization demand information through the semantic analysis model, and generating translated customization information based on the customization demand information; and
performing semantic disassembly on the translated customization information through the semantic analysis model, and generating and outputting the analyzed customization information based on the translated customization information.

12. The computing device according to claim 8, wherein the method for generating customized images further comprises the following steps of:
inputting the at least one first retrieved image into an image editing model; and
performing image editing on the at least one first retrieved image through the image editing model, and generating and outputting at least one edited image based on the at least one first retrieved image,
wherein the image editing model is a trained artificial intelligence engine.

13. The computing device according to claim 8, wherein the method for generating customized images further comprises the following steps of:
receiving a customized merchandise image corresponding to merchandise information for customization;
inputting the at least one first retrieved image and the customized merchandise image into an image synthesis model; and
performing image synthesis on the at least one first retrieved image and the customized merchandise image through the image synthesis model, and generating and outputting at least one synthesized image based on the at least one first retrieved image and the customized merchandise image,
wherein the image synthesis model is a trained artificial intelligence engine.

14. The computing device according to claim 13, wherein the method for generating customized images further comprises the following steps of:
selecting from the at least one synthesized image by a user to obtain a selected image and outputting the selected image to an ordering system.

15. A non-transitory computer-readable recording medium for generating customized images, after a computing device loads a computer program product stored in the non-transitory computer-readable recording medium and executes the computer program product, the computing device performs a method for generating customized images, and the method for generating customized images comprising the following steps of:
receiving customization demand information;
inputting the customization demand information into a semantic analysis model;
performing a semantic analysis on the customization demand information through the semantic analysis model, and generating and outputting analyzed customization information based on the customization demand information;
searching for a plurality of semantic images associated with the analyzed customization information from an image classification database, and receiving the plurality of semantic images, and/or inputting at least one of the customization demand information and the analyzed customization information into an image generation model, and generating and outputting at least one initial image based on at least one of the customization demand information and the analyzed customization information through the image generation model;
inputting the plurality of semantic images and/or the at least one initial image into an image analysis and screening model; and
performing image analysis and screening on the plurality of semantic images and/or the at least one initial image through the image analysis and screening model, and screening the plurality of semantic images and/or the at least one initial image based on at least one of the customization demand information and the analyzed customization information to obtain at least one first retrieved image,
wherein the semantic analysis model, the image generation model and the image analysis and screening model are respectively trained artificial intelligence engines.

16. The non-transitory computer-readable recording medium according to claim 15, wherein the method for generating customized images further comprises the following steps of:
determining whether a total number of the at least one first retrieved image is less than a predetermined value; and
when the total number of the at least one first retrieved image is less than the predetermined value, inputting at least one of the customization demand information and the analyzed customization information into the image generation model, and generating and outputting at least one generated image based on at least one of the customization demand information and the analyzed customization information through the image generation model,
wherein a total number of the at least one generated image is greater than or equal to a difference between the total number of the at least one first retrieved image and the predetermined value.

17. The non-transitory computer-readable recording medium according to claim 16, wherein the method for generating customized images further comprises the following steps of:
inputting the at least one generated image into the image analysis and screening model;
performing image analysis and screening on the at least one generated image through the image analysis and screening model, and screening the at least one generated image based on at least one of the customization demand information and the analyzed customization information to obtain at least one second retrieved image;
determining whether a total number of the at least one second retrieved image is less than the difference; and
when the total number of the at least one second retrieved image is less than the difference, generating and outputting the at least one generated image again based on at least one of the customization demand information and the analyzed customization information through the image generation model, and screening the at least one generated image again based on at least one of the customization demand information and the analyzed customization information through the image analysis and screening model to obtain the at least one second retrieved image, until the total number of the at least one generated screening image is greater than or equal to the difference.

18. The non-transitory computer-readable recording medium according to claim 15, wherein the step of performing a semantic analysis on the customization demand information through the semantic analysis model, and generating and outputting the analyzed customization information based on the customization demand information comprises the following sub-steps:
performing language translation on the customization demand information through the semantic analysis model, and generating translated customization information based on the customization demand information; and
performing semantic disassembly on the translated customization information through the semantic analysis model, and generating and outputting the analyzed customization information based on the translated customization information.

19. The non-transitory computer-readable recording medium according to claim 15, wherein the method for generating customized images further comprises the following steps of:
inputting the at least one first retrieved image into an image editing model; and
performing image editing on the at least one first retrieved image through the image editing model, and generating and outputting at least one edited image based on the at least one first retrieved image,
wherein the image editing model is a trained artificial intelligence engine.

20. The non-transitory computer-readable recording medium according to claim 15, wherein the method for generating customized images further comprises the following steps of:
receiving a customized merchandise image corresponding to merchandise information for customization;
inputting the at least one first retrieved image and the customized merchandise image into an image synthesis model; and
performing image synthesis on the at least one first retrieved image and the customized merchandise image through the image synthesis model, and generating and outputting at least one synthesized image based on the at least one first retrieved image and the customized merchandise image,
wherein the image synthesis model is a trained artificial intelligence engine.

21. The non-transitory computer-readable recording medium according to claim 20, wherein the method for generating customized images further comprises the following steps of:
selecting from the at least one synthesized image by a user to obtain a selected image and outputting the selected image to an ordering system.
